(19) United States
(12) Patent Application Publication
(10) Pub. No.: US 2025/0253675 A1
(43) Pub. Date: Aug. 7, 2025

(54) MULTI-VOLTAGE BATTERY MANAGER

(71) Applicant: Caterpillar Inc., Peoria, IL (US)

(72) Inventors: Swati Narula, Bengaluru (IN); Swati Kumari, Patna (IN); M Vijay Kumar, Yadgir (IN); Aravinth Manivannan, Bengaluru (IN); Bryan Johnson, Montgomery, IL (US)

(73) Assignee: Caterpillar Inc., Peoria, IL (US)

(21) Appl. No.: 18/433,594

(22) Filed: Feb. 6, 2024

(51) Int. Cl. H02J 7/00

(52) U.S. Cl. CPC H02J 7/00047; H02J 7/00309; H02J 7/007182; H02J 2207/20; H02J 2207/40

(57) ABSTRACT

A battery manager for a battery is disclosed. The battery manager comprises a battery charger configured to provide a first output voltage in a first voltage range, a buck-boost direct current to direct current (DC to DC) converter switchably coupled to the battery charger, and a bypass line switchably coupled between the battery charger and the battery for bypassing the buck-boost DC to DC converter. The battery manager further comprises a controller configured to electrically route the first output voltage of the battery charger to the battery via the bypass line when a voltage requirement of the battery is within the first voltage range. The controller is further configured to electrically route the first output voltage of the battery charger to the battery via the buck-boost DC to DC converter when the voltage requirement of the battery is outside the first voltage range.

### TECHNICAL FIELD

The present disclosure relates to a multi-voltage battery manager. More particularly, the present disclosure relates to a multi-voltage battery manager for charging/discharging batteries with different voltage requirements.

### BACKGROUND

A battery manager is generally used for charging or discharging a rechargeable battery, e.g., batteries used in electric vehicles, renewable energy systems, portable electronic devices etc. The battery manager generally manages a battery by controlling the charging and discharging processes of the battery. Each battery manager may have an output voltage range that can be used to charge or discharge batteries operating in the corresponding voltage range. For instance, a forty eight (48) volts battery manager can only charge or discharge batteries having a voltage requirement of about 48 volts. Similarly, a battery manager having an output voltage in the range of two hundred and ten (210) volts to eight hundred and forty (840) volts can only charge or discharge batteries having voltage requirement in the same range.

European publication 3028338 discloses a first battery coupled to an electrical system having a first battery chemistry. It further discloses a second battery coupled in parallel with the first battery and selectively coupled to the electrical system via a DC/DC converter, in which the second battery includes a second battery chemistry having a higher coulombic efficiency than the first battery chemistry. The DC/DC converter boosts a first voltage to a second voltage to charge the second battery during regenerative braking, in which the second voltage is higher than the maximum charging voltage of the first battery.

### SUMMARY

In one aspect, the present disclosure relates to a battery manager for a battery. The battery manager includes a battery charger configured to provide a first output voltage in a first voltage range. The battery manager further includes a buck-boost direct current to direct current (DC to DC) converter switchably coupled to the battery charger and a bypass line switchably coupled between the battery charger and the battery for bypassing the buck-boost DC to DC converter. The battery manager further includes a controller configured to determine a first condition when a voltage requirement of the battery is within the first voltage range, and electrically route the first output voltage of the battery charger to the battery via the bypass line in response to the first condition. The controller is further configured to determine a second condition when the voltage requirement of the battery is outside the first voltage range, and electrically route the first output voltage of the battery charger to the battery via the buck-boost DC to DC converter in response to the second condition.

In another aspect, the present disclosure is directed to a battery management system including a battery and a battery manager for the battery. The battery manager includes a battery charger configured to provide a first output voltage in a first voltage range. The battery manager further includes a buck-boost direct current to direct current (DC to DC) converter switchably coupled to the battery charger and a bypass line switchably coupled between the battery charger and the battery for bypassing the buck-boost DC to DC converter. The battery manager further includes a controller configured to determine a first condition when a voltage requirement of the battery is within the first voltage range, and electrically route the first output voltage of the battery charger to the battery via the bypass line in response to the first condition. The controller is further configured to determine a second condition when the voltage requirement of the battery is outside the first voltage range, and electrically route the first output voltage of the battery charger to the battery via the buck-boost DC to DC converter in response to the second condition.

In yet another aspect, the present disclosure relates to a method for charging a battery. The method includes using a battery charger to provide a first output voltage in a first voltage range. The method further includes switchably coupling a buck-boost direct current to direct current (DC to DC) converter to the battery charger, and switchably coupling a bypass line between the battery charger and the battery for bypassing the buck-boost DC to DC converter. The method further includes determining, by a controller, a first condition when a voltage requirement of the battery is within the first voltage range, and electrically routing, by the controller, the first output voltage of the battery charger to the battery via the bypass line in response to the first condition. The method further includes determining, by the controller, a second condition when the voltage requirement of the battery is outside the first voltage range, and electrically routing, by the controller, the first output voltage of the battery charger to the battery via the buck-boost DC to DC converter in response to the second condition.

### BRIEF DESCRIPTION

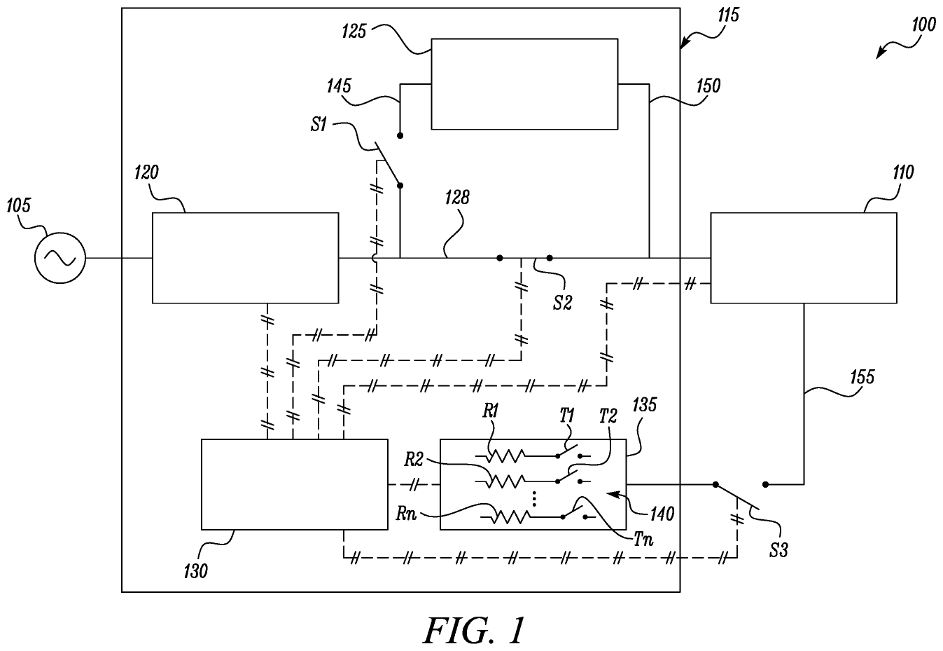

FIG. 1 is a schematic view of an exemplary battery management system operating in a first condition, according to an embodiment of the present disclosure;

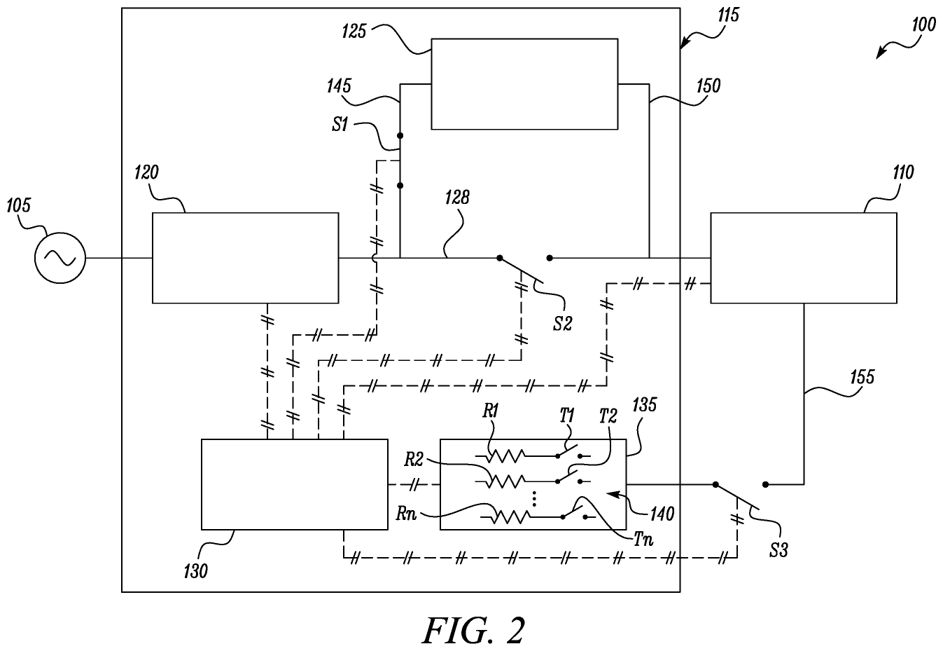

FIG. 2 is a schematic view of the exemplary battery management system operating in a second condition, according to an embodiment of the present disclosure;

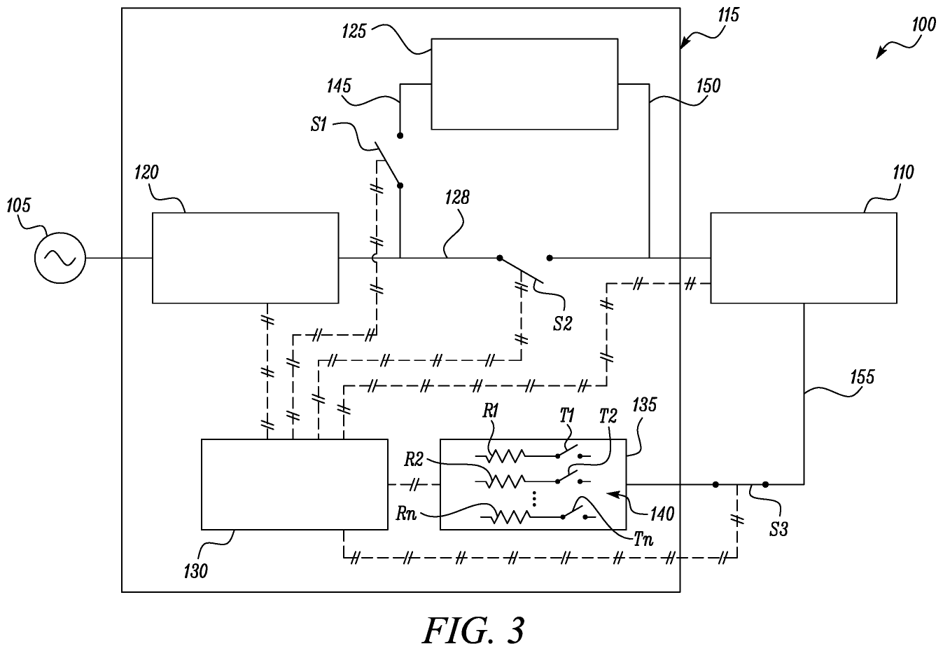

FIG. 3 is a schematic view of the exemplary battery management system performing a discharging operation, according to an embodiment of the present disclosure; and

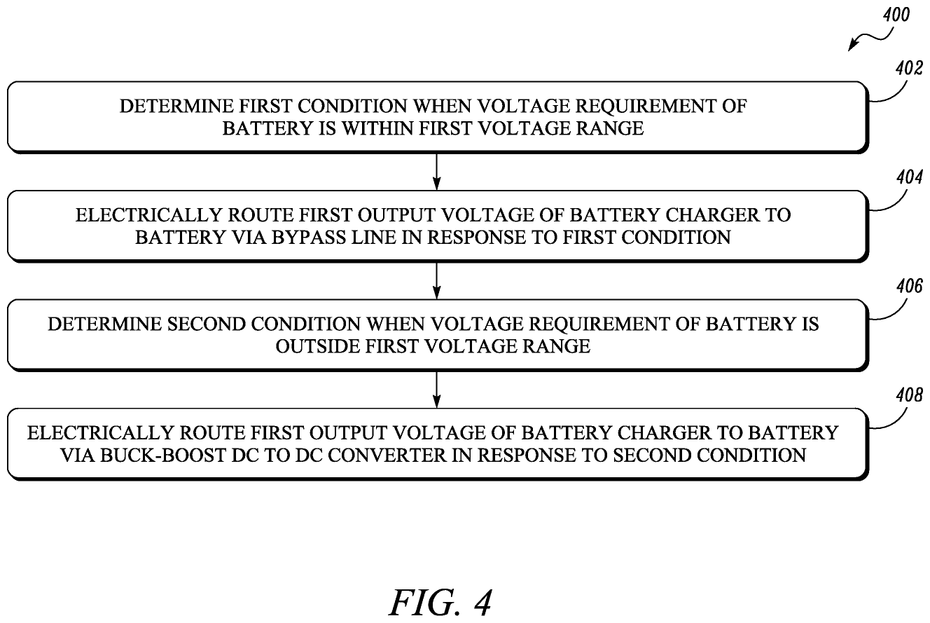

FIG. 4 is a method for charging a battery included in the battery management system of FIGS. 1 through 3, according to an embodiment of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

Referring to FIGS. 1 through 3, an exemplary battery management system 100 is shown and described. The battery management system 100 is configured to monitor and control various functions, such as, charging and discharging of a rechargeable battery, for example, a battery 110, to optimize the life and performance of the battery 110. The battery management system 100 may be employed in diverse environments, including but not limited to, electric work machines, construction machines, mining machine, power generation systems, renewable energy systems, electronic devices, etc., e.g., to monitor and control the functioning of rechargeable batteries employed in such environments.

In accordance with various embodiments, the battery management system 100 may include the battery 110. The battery 110 may be a rechargeable battery that can be repeatedly charged and discharged. For example, the battery 110 may include, but not limited to, a Lead-Acid battery, a Lithium-Ion battery, a Nickel-Cadmium battery, and the like. The battery 110 may have different voltage requirements, for example, depending upon a type and a size of the battery 110. The voltage requirement may correspond to a specific voltage level needed to safely and effectively charge the battery 110. In an example, the battery 110 may be a battery having the voltage requirement of 48 volts. In another example, the battery 110 may be a battery having the voltage requirement in the range of 210 volts to 840 volts. These examples are provided for illustrative purposes only.

The battery management system 100 may further include a battery manager 115 for the battery 110. In accordance with various embodiments, the battery manager 115 may be a multi-voltage battery manager configured to control the charging and discharging of any battery having any voltage requirement or operable in any voltage range. In an example, the battery manager 115 may be configured to control the charging and discharging of the battery 110 having the voltage requirement of 48 volts. In an example, the battery manager 115 may be configured to control the charging and discharging of the battery 110 having the voltage requirement in the range of 210 volts to 840 volts.

The battery manager 115 may include a battery charger 120 configured to provide a first output voltage in a first voltage range. The battery charger 120 may include any suitable type of battery charger, including a commercially available battery charger, now known or in the future developed, or a proprietary battery charger. The battery charger 120 may be configured to receive an alternating current (AC) (e.g., from a power source 105) and convert the same into direct current (DC) corresponding to the first output voltage in the first voltage range. The power source 105 may be any AC power source, such as but not limited to, AC mains electricity. In accordance with various embodiments, the first voltage range may be a predetermined voltage range. In an exemplary embodiment, the first voltage range lies between 210 volts to 840 volts.

The battery manager 115 may further include a buck-boost direct current to direct current (DC to DC) converter 125. The buck-boost DC to DC converter 125 may be configured to buck or boost the first output voltage received from the battery charger 120 via a first electrical line 145. The buck-boost DC to DC converter 125 may be configured to buck the first output voltage received from the battery charger 120 to provide a second output voltage in a second voltage range. The second voltage range may correspond to a voltage range lower than the first voltage range (e.g., lower than a lower limit of the first voltage range). The buck-boost DC to DC converter 125 may also be configured to boost the first output voltage received from the battery charger 120 to provide a third output voltage in a third voltage range. The third voltage range may correspond to a voltage range higher than the first voltage range (e.g., higher than an upper limit of the first voltage range). The buck-boost DC to DC converter 125 may be further configured to provide and/or route the second output voltage or the third output voltage to the battery 110 via a second electrical line 150 such that the battery 110 can be suitably charged. In accordance with various embodiments, and as may be understood from the description above, the second voltage range and the third voltage range may be outside the first voltage range.

The buck-boost DC to DC converter 125 may be switchably coupled to the battery charger 120. To this end, a switch S1 may be disposed between the buck-boost DC to DC converter 125 and the battery charger 120, e.g., on the first electrical line 145, for connecting and/or disconnecting the buck-boost DC to DC converter 125 and the battery charger 120. The switch S1 may be movable between an open state and a closed state. When the switch S1 is in the open state (as shown in FIG. 1), the buck-boost DC to DC converter 125 may be disconnected (e.g., electrically disconnected) from the battery charger 120. Conversely, when the switch S1 is in the closed state (as shown in FIG. 2), the buck-boost DC to DC converter 125 may be connected to the battery charger 120. When the buck-boost DC to DC converter 125 is connected (e.g., electrically connected) to the battery charger 120, the first output voltage of the battery charger 120 may be electrically routed to the battery 110 via the buck-boost DC to DC converter 125.

The battery manager 115 may further include a bypass line 128 switchably coupled between the battery charger 120 and the battery 110 for bypassing the buck-boost DC to DC converter 125. A switch S2 may be disposed on the bypass line 128 between the battery charger 120 and the battery 110 for (e.g., selectively) connecting or disconnecting the battery charger 120 with the battery 110. The switch S2 may be movable between an open state and a closed state. When the switch S2 is in the open state (as shown in FIG. 2), the battery charger 120 may be disconnected from the battery 110. Conversely, when the switch S2 is in the closed state (as shown in FIG. 1), the battery charger 120 may be connected to the battery 110. When the battery charger 120 is connected to the battery 110 via the bypass line 128, the first output voltage of the battery charger 120 is electrically routed to the battery 110 via the bypass line 128.

The battery manager 115 may further include a heat dissipator circuit 135. The heat dissipator circuit 135 may be configured to be switchably coupled to the battery 110 via a third electrical line 155. To this end, a switch S3 may be disposed between the battery 110 and the heat dissipator circuit 135, for e.g., on the third electrical line 155, for selectively connecting or disconnecting the battery 110 with the heat dissipator circuit 135. When the switch S3 is in an open state (as shown in FIGS. 1 and 2), the battery 110 is disconnected from the heat dissipator circuit 135. Conversely, when the switch S3 is in a closed state (as shown in FIG. 3), the battery 110 is connected to the heat dissipator circuit 135. When the battery 110 is connected to the heat dissipator circuit 135, the heat dissipator circuit 135 may be utilized to discharge the battery 110.

The heat dissipator circuit 135 may include a plurality of heat dissipating elements 140. Each heat dissipating element 140 may be switchably coupled to the battery 110, e.g., by way of corresponding switches T1, T2, . . . . Tn. For discharging the battery 110, one or more of the switches T1, T2, . . . . Tn may be moved to their corresponding closed state so as to establish an electrical connection between the battery 110 and said switches T1, T2, . . . . Tn. As an example, the heat dissipating elements 140 may be configured to discharge the battery 110 by, e.g., receiving an electrical energy from the battery 110 and converting the electrical energy into heat which may then be disposed to a sink (e.g., the surrounding environment). For example, the heat dissipating elements 140 may include resistors (e.g., corresponding resistors R1, R2, . . . . Rn) for receiving and converting the electrical energy of the battery 110 into heat. In accordance with various embodiments, each heat dissipating element 140 may have different heat receiving and/or dissipating capabilities. For example, the resistor R2 may be configured to dissipate more heat as compared to the resistor R1.

The battery manager 115 may further include a controller 130 coupled to the battery charger 120, the switch S1, the switch S2, the battery 110, the switch S3, and the switches T1, T2, . . . . Tn of the heat dissipator circuit 135. The controller 130 may include a computing device having a single microprocessor or multiple microprocessors. For example, the controller 130 may include a memory, a secondary storage device, a clock, and a processing hardware for accomplishing a task consistent with the present disclosure. The controller 130 may be configured to receive data inputs from each component of the battery management system 100, process the data, and generate output signals based on the inputs and/or processed data.

The controller 130 is configured to determine a first condition when the voltage requirement of the battery 110 is within the first voltage range. To this end, the controller 130 is configured to determine the voltage requirement of the battery 110 and the first voltage range of the first output voltage provided by the battery charger 120, using one or more sensors, such as, voltage sensors (e.g., voltmeters) (not shown). It would be appreciated that a determination of the voltage requirement of a battery and an output voltage of a battery charger can be performed using various sensors/techniques known in the art, the details of which are not described here for the sake of brevity.

In response to the first condition, the controller 130 is configured to electrically route the first output voltage of the battery charger 120 to the battery 110 via the bypass line 128. To this end, the controller 130 may be configured to control the switch S2 and move the switch S2 to the closed position (as shown in FIG. 1) to connect the battery charger 120 (e.g., directly) to the battery 110. During the first condition, the controller 130 may be also configured to control the switch S1 and move the switch S1 to the open position (as shown in FIG. 1), thereby disconnecting the buck-boost DC to DC converter 125 from the battery charger 120. Furthermore, during the first condition, the controller 130 may be also configured to control the switch S3 and move the switch S3 to the open position (as shown in FIGS. 1 and 2), thereby disconnecting the heat dissipator circuit 135 from the battery 110.

The controller 130 is further configured to determine a second condition when the voltage requirement of the battery 110 is outside the first voltage range, e.g., by retrieving data for the voltage sensors. In response to the second condition, the controller 130 is configured to electrically route the first output voltage of the battery charger 120 to the battery 110 via the buck-boost DC to DC converter 125. To this end, the controller 130 may be configured to control the switch S1 and move the switch S1 to the closed position (as shown in FIG. 2) to connect the battery charger 120 (e.g., directly) to the buck-boost DC to DC converter 125. During the second condition, the controller 130 may be also configured to control the switch S2 and move the switch S2 to the open position (as shown in FIG. 2), thereby disabling any electrical route or travel path via the bypass line 128 between the battery charger 120 and the battery 110. Furthermore, during the second condition, the controller 130 may be also configured to control the switch S3 and move the switch S3 to the open position (as shown in FIGS. 1 and 2), thereby disconnecting the heat dissipator circuit 135 from the battery 110.

In an embodiment, when the voltage requirement of the battery 110 is outside the first output voltage range, the controller 130 is configured to issue a first signal to the buck-boost DC to DC converter 125 to convert the first output voltage to the second output voltage in the second voltage range. For example, when the voltage requirement of the battery 110 is in the second voltage range, the controller 130 is configured to issue the first signal to the buck-boost DC to DC converter 125 to step-down the first output voltage to the second output voltage. Upon receiving the first signal, the buck-boost DC to DC converter 125 is configured to step-down the first output voltage to the second output voltage, such that the second output voltage may be provided to the battery 110.

In another embodiment, when the voltage requirement of the battery 110 is outside the first output voltage range, the controller 130 is configured to issue a second signal to the buck-boost DC to DC converter 125 to convert the first output voltage to the third output voltage in the third voltage range. For example, when the voltage requirement of the battery 110 is in the third voltage range, the controller 130 is configured to issue the second signal to the buck-boost DC to DC converter to step-up the first output voltage to the third output voltage. Upon receiving the second signal, the buck-boost DC to DC converter 125 is configured to step-up the first output voltage to the third output voltage, such that the third output voltage may be provided to the battery 110.

Now, an exemplary discharging operation of the battery 110 will be discussed. During the discharging operation of the battery 110, the battery manager 115 may discharge the battery 110 depending on the voltage requirement of the battery 110. Upon receiving a discharging request from a user, e.g., an operator, the controller 130 may connect the heat dissipator circuit 135 to the battery 110 by closing the switch S3 disposed on the third electrical line 155 (as shown in FIG. 3). Further, the controller 130 may determine the voltage requirement of the battery 110 by using the voltage determining means. Based on the voltage requirement of the battery 110, the controller 130 may couple one or more heat dissipating elements 140 with the battery 110 by closing the corresponding switches T1, T2, . . . . Tn. For example, if the voltage requirement of the battery 110 to be discharged is 48V, the controller 130 may determine a corresponding number of the heat dissipating elements 140 that may be required to discharge the battery 110. The controller 130 may then couple the corresponding number of the heat dissipating elements 140 with the battery 110 by closing the switches T1, T2, . . . . Tn associated with the corresponding number of the heat dissipating elements 140. In one embodiment, the corresponding number of the heat dissipating elements 140 coupled to the battery is directly proportional to the voltage requirement of the battery 110. During the discharging operation, the controller 130 may be also configured to control the switches S1 and S2, and move the switches S1 and S2 to the open position (as shown in FIG. 3), thereby disabling any electrical route or travel path between the battery charger 120 and the battery 110.

In an embodiment, the heat dissipating elements 140 may have different heat dissipating capacities. For instance, one heat dissipating element 140, for example the resistor R1, may be utilized to discharge a battery 110 having an output voltage up to 48 volts. Similarly, another single heat dissipating element 140, for example the resistor R2, may be utilized to discharge a battery 110 having an output voltage up to 240V, and so on. Based on the voltage requirement of the battery 110, the controller 130 may couple one or more heat dissipating elements 140, for example the resistors R1, R2, . . . . Rn, having similar or different heat dissipating capacities, to the battery 110 for discharging the battery 110, e.g., by closing (or opening) one or more of the switches T1, T2, . . . . In that are associated with the corresponding heat dissipating elements 140.

### INDUSTRIAL APPLICABILITY

FIG. 4 describes an exemplary method 400 for charging the battery 110, having any voltage requirement, by using the multi-voltage battery manager 115. The method 400 is discussed by way of a flowchart and is discussed in conjunction with FIGS. 1 to 2, as well. It will be appreciated that the order of steps described in the method 400 is exemplary in nature and that the steps can be performed in a different order than what is set out below, as will be contemplated by a person skilled in the art based on the description of the present disclosure.

The method 400 begins with the controller 130 determining the first condition when the voltage requirement of the battery 110 is within the first voltage range at block 402. At block 404, the controller 130 electrically routes the first output voltage of the battery charger 120 to the battery 110 via the bypass line 128 in response to the first condition (e.g., by closing the switch S2 and opening the switch S1) (see FIG. 1). At block 406, the controller 130 determines the second condition when the voltage requirement of the battery 110 is outside the first voltage range. At block 408, the controller 130 electrically routes the first output voltage of the battery charger 120 to the battery 110 via the buck-boost DC to DC converter 125 in response to the second condition (e.g., by closing the switch S1 and opening the switch S2) (see FIG. 2).

The present disclosure provides the multi-voltage battery manager 115 and method 400 for charging and discharging batteries with different voltage requirements. In other words, the present disclosure provides for charging or discharging batteries (e.g., battery 110) having different voltage requirements by way of the single, battery manager 115, negating the need to have multiple battery managers or multiple charging (and discharging) systems. Depending upon the voltage requirement of the battery 110, the battery manager 115 may charge the battery 110 directly via the bypass line 128 or via the DC to DC converter 125 to meet the voltage requirement of the battery 110. Hence, multiple battery chargers are not required for charging the batteries having different voltage requirements. Furthermore, the multi-voltage battery manager 115 also have the provision to discharge such batteries with different voltage requirements.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A battery manager for a battery, the battery manager comprising:
a battery charger configured to provide a first output voltage in a first voltage range;
a buck-boost direct current to direct current (DC to DC) converter switchably coupled to the battery charger;
a bypass line switchably coupled between the battery charger and the battery for bypassing the buck-boost DC to DC converter; and
a controller configured to:
determine a first condition when a voltage requirement of the battery is within the first voltage range;
electrically route the first output voltage of the battery charger to the battery via the bypass line in response to the first condition;
determine a second condition when the voltage requirement of the battery is outside the first voltage range; and
electrically route the first output voltage of the battery charger to the battery via the buck-boost DC to DC converter in response to the second condition.

2. The battery manager of claim 1, wherein the controller is further configured to issue a first signal to convert the first output voltage to a second output voltage in a second voltage range, or issue a second signal to convert the first output voltage to a third output voltage in a third voltage range, to the buck-boost DC to DC converter when the voltage requirement of the battery is outside the first voltage range, wherein the second voltage range and the third voltage range are outside the first voltage range.

3. The battery manager of claim 2, wherein the second voltage range corresponds to a voltage range lower than the first voltage range, and wherein the controller is configured to issue the first signal to the buck-boost DC to DC converter to step-down the first output voltage to the second output voltage when the voltage requirement of the battery is in the second voltage range.

4. The battery manager of claim 2, wherein the third voltage range corresponds to a voltage range higher than the first voltage range, and wherein the controller is configured to issue the second signal to the buck-boost DC to DC converter to step-up the first output voltage to the third output voltage when the voltage requirement of the battery is in the third voltage range.

5. The battery manager of claim 1, wherein the first voltage range of the battery charger lies between 210 volts to 840 volts.

6. The battery manager of claim 1, further including:
a heat dissipator circuit including a plurality of heat dissipating elements switchably coupled to the battery for discharging the battery, wherein the controller is configured to couple one or more heat dissipating elements of the plurality of heat dissipating elements with the battery, and wherein a number of the one or more heat dissipating elements coupled to the battery is directly proportional to the voltage requirement of the battery.

7. The battery manager of claim 6, wherein each of the plurality of heat dissipating elements includes different heat dissipating capacities.

8. A battery management system comprising:
a battery; and
a battery manager for the battery comprising:
a battery charger configured to provide a first output voltage in a first voltage range;
a buck-boost direct current to direct current (DC to DC) converter switchably coupled to the battery charger;
a bypass line switchably coupled between the battery charger and the battery for bypassing the buck-boost DC to DC converter; and
a controller configured to:
determine a first condition when a voltage requirement of the battery is within the first voltage range;
electrically route the first output voltage of the battery charger to the battery via the bypass line in response to the first condition;
determine a second condition when the voltage requirement of the battery is outside the first voltage range; and
electrically route the first output voltage of the battery charger to the battery via the buck-boost DC to DC converter in response to the second condition.

9. The battery management system of claim 8, wherein the controller is further configured to issue a first signal to convert the first output voltage to a second output voltage in a second voltage range, or issue a second signal to convert the first output voltage to a third output voltage in a third voltage range, to the buck-boost DC to DC converter when the voltage requirement of the battery is outside the first voltage range, wherein the second voltage range and the third voltage range are outside the first voltage range.

10. The battery management system of claim 9, wherein the second voltage range corresponds to a voltage range lower than the first voltage range, and wherein the controller is configured to issue the first signal to the buck-boost DC to DC converter to step-down the first output voltage to the second output voltage when the voltage requirement of the battery is in the second voltage range.

11. The battery management system of claim 9, wherein the third voltage range corresponds to a voltage range higher than the first voltage range, and wherein the controller is configured to issue the second signal to the buck-boost DC to DC converter to step-up the first output voltage to the third output voltage when the voltage requirement of the battery is in the third voltage range.

12. The battery management system of claim 8, wherein the first voltage range of the battery charger lies between 210 volts to 840 volts.

13. The battery management system of claim 8, further including:
a heat dissipator circuit including a plurality of heat dissipating elements switchably coupled to the battery for discharging the battery, wherein the controller is configured to couple one or more heat dissipating elements of the plurality of heat dissipating elements with the battery, and wherein a number of the one or more heat dissipating elements coupled to the battery is directly proportional to the voltage requirement of the battery.

14. The battery management system of claim 13, wherein each of the plurality of heat dissipating elements includes different heat dissipating capacities.

15. A method for charging a battery, the method comprising:
using a battery charger to provide a first output voltage in a first voltage range;
switchably coupling a buck-boost direct current to direct current (DC to DC) converter to the battery charger;
switchably coupling a bypass line between the battery charger and the battery for bypassing the buck-boost DC to DC converter;
determining, by a controller, a first condition when a voltage requirement of the battery is within the first voltage range;
electrically routing, by the controller, the first output voltage of the battery charger to the battery via the bypass line in response to the first condition;
determining, by the controller, a second condition when the voltage requirement of the battery is outside the first voltage range; and
electrically routing, by the controller, the first output voltage of the battery charger to the battery via the buck-boost DC to DC converter in response to the second condition.

16. The method of claim 15, further including
issuing, by the controller, a first signal to convert the first output voltage to a second output voltage in a second voltage range, or issuing, by the controller, a second signal to convert the first output voltage to a third output voltage in a third voltage range, to the buck-boost DC to DC converter when the voltage requirement of the battery is outside the first voltage range, wherein the second voltage range and the third voltage range are outside the first voltage range.

17. The method of claim 16, wherein the second voltage range corresponds to a voltage range lower than the first voltage range, and wherein the method further includes stepping down, by the buck-boost DC to DC converter, the first output voltage to the second output voltage when the voltage requirement of the battery is lower than the first voltage range.

18. The method of claim 16, wherein the third voltage range corresponds to a voltage range higher than the first voltage range, and wherein the method further includes stepping up, by the buck-boost DC to DC converter, the first output voltage to the third output voltage when the voltage requirement of the battery is higher than the first voltage range.

19. The method of claim 15, wherein the first voltage range of the battery charger lies between 210 volts to 840 volts.

20. The method of claim 15, further including:
coupling, by the controller, one or more heat dissipating elements of a plurality of heat dissipating elements of a heat dissipator circuit with the battery, wherein a number of the one or more heat dissipating elements coupled to the battery is directly proportional to the voltage requirement of the battery, and wherein each of the plurality of heat dissipating elements includes different heat dissipating capacities.
